(19) United States
(12) Patent Application Publication
(10) Pub. No.: US 2026/0169847 A1
(43) Pub. Date: Jun. 18, 2026

(54) METHOD FOR TRANSFERRING LOG DATA FROM AN EXECUTION OF A COMPUTER PROGRAM

(71) Applicant: Robert Bosch GmbH, Stuttgart (DE)

(72) Inventors: Timon Reich, Schwieberdingen (DE); Andre-Marcel Hellmund, Hockenheim (DE); Raphael Diziol, Kandel (DE)

(21) Appl. No.: 18/729,529

(22) PCT Filed: Dec. 28, 2022
(86) PCT No.: PCT/EP2022/087926

§ 371 Date: Sep. 19, 2024

(30) Foreign Application Priority Data
Jan. 20, 2022 (DE) 10 2022 200 658.5

(51) Int. Cl. G06F 11/07

(52) U.S. Cl. CPC G06F 11/0784; G06F 11/0721; G06F 11/0769

(57) ABSTRACT

A method for transferring log data from an execution of a computer program. The method includes: generating an indexed list of identifiers of user-defined log-statement-argument data types; before execution of the program, for each log statement of a set of log statements for outputting log data that is contained in the program, transferring static log data to a log data receiver; and, upon execution of the program, for each log statement of the set of log statements that is executed during execution of the program, transferring, dynamic log data for the log statement, and wherein, if the log statement uses one of the user-defined log-statement-argument data types for outputting dynamic log data, the dynamic log data contain an index of the identifier of the log-statement-argument data type.

### FIELD

The present invention relates to a method for transferring log data from an execution of a computer program.

### BACKGROUND INFORMATION

Computer programs typically need to be checked for errors. This applies in particular to control programs in safety-relevant applications, such as control software for a (possibly autonomous) vehicle. This is done by examining log data from the execution of a particular computer program. In certain applications, such as control software in a vehicle, it is desirable that flexible (for example, user-defined) data structures can be used for such log data and at the same time the effort on the sending side (here the vehicle) is low due to its limited computing resources, for example.

### SUMMARY

According to various example embodiments of the present invention, a method for transferring log data from an execution of a computer program is provided, comprising: generating an indexed list of identifiers of user-defined log-statement-argument data types; before execution of the program, for each log statement of a set of log statements for outputting log data that is contained in the program, transferring static log data to a log data receiver, the static log data being log data that, from execution to execution of the program, remain the same for the log statement; and, upon execution of the program, for each log statement of the set of log statements that is executed during execution of the program, transferring, dynamic log data for the log statement, the dynamic log data being log data that may vary from execution to execution of the program, and, if the log statement uses one of the user-defined log-statement-argument data types for outputting dynamic log data, the dynamic log data containing an index of the identifier of the log-statement-argument data type.

The method according to the present invention described above makes possible an efficient transfer of log data (and thus efficient logging) by separating statistical and dynamic log data. This happens in particular for user-defined log-statement-argument data types and thus for flexibly definable data types that are used for the transfer of log data (and the structuring thereof).

Separating static and dynamic log data significantly increases logging performance. The use of user-defined log-statement-argument data types (also referred to simply as log data types) makes possible the logging of structured log data in this context. This can be used, for example, for tracing (for visualization and forensic reconstruction of program execution) in order to trace using (downstream) deserialization.

Various exemplary embodiments of the present invention are specified below.

Exemplary embodiment 1 is the method described above for transferring log data from an execution of a computer program.

Exemplary embodiment 2 is a method according to exemplary embodiment 1, wherein if the log statement uses one of the user-defined log-statement-argument data types for outputting dynamic log data, the dynamic log data contain raw data for the log-statement-argument data type and an indication of the data volume of the raw data.

In this way, the quantity of raw data transferred using a user-defined log-statement-argument data type can be flexibly adjusted, since it is part of the dynamic data for the log-statement-argument data type (and is not statically set).

Exemplary embodiment 3 is a method according to exemplary embodiment 1 or 2, comprising transferring the dynamic log data via a communication channel, reception of the dynamic log data by the receiver, checking whether the dynamic log data contain an index of a log-statement-argument data type, obtaining, if the dynamic log data contain an index of a log-statement-argument data type, information about the log-statement-argument data type, and converting the dynamic log data into a data structure according to the information about the log-statement-argument data type. Conversion can be considered as the actual deserialization of the user-defined log data. Checking, obtaining information about the log-statement-argument data type and conversion take place, for example, on the side of the receiver of the log data (for example a server and/or a cloud) that performs an analysis of the log data. However, the sender of the log data (for example a vehicle) does not carry out this complex processing and writes the log data, for example one-to-one, into an archive (for later forwarding to the receiver).

In this way, a receiver (for example a server or host that analyzes the log data and/or prepares them for a user) can correctly structure and further process the dynamic data (in particular raw data) transferred for a log-statement-argument data type.

Exemplary embodiment 4 is a method according to exemplary embodiment 3, wherein the information about the log-statement-argument data type comprises designations of elements of the log-statement-argument data type.

This makes it possible, for example, for the raw data transferred for a log-statement-argument data type to be displayed to a user with the correct designations. For example, in a visualization of the execution of the computer program, the log data can then be displayed directly and hierarchically.

Exemplary embodiment 5 is a method according to one of exemplary embodiments 1 to 4, wherein the identifier of each log-statement-argument data type is a hash of a syntax tree of the log-statement-argument data type.

The use of such hashes makes possible an easy generation of unique identifiers.

Exemplary embodiment 6 is a method according to one of exemplary embodiments 1 to 5, wherein the static log data are a location of the log statement, a channel severity level of a log message output by the log statement, and/or an argument layout of the log statement.

This information does not change between runs of the program. By an advance transfer (for example to a server), the volume of log data transferred during program execution can be reduced. The channel can in particular represent a severity level. Examples of channels are TIME, TRACE, EVENT, DEBUG, STATUS, INFO, WARNING, ERROR and FATAL.

Exemplary embodiment 7 is a method according to one of exemplary embodiments 1 to 6, wherein the log data types are classes of an object-oriented programming language.

This makes possible a flexible structuring of the log data.

Exemplary embodiment 8 is a data processing arrangement which is configured to perform a method according to one of exemplary embodiments 1 to 7.

Exemplary embodiment 9 is a computer program comprising instructions that, when executed by one or more processors, cause the one or more processors to carry out a method according to one of exemplary embodiments 1 to 7.

Exemplary embodiment 10 is a computer-readable medium storing instructions that, when executed by one or more processors, cause the one or more processors to carry out a method according to one of exemplary embodiments 1 to 7.

In the figures, similar reference signs generally refer to the same parts throughout the various views. The figures are not necessarily true to scale, with emphasis instead generally being placed on the representation of the principles of the present invention. In the following description, various aspects are described with reference to the figures.

### BRIEF DESCRIPTION OF THE DRAWINGS

FIG. 1 shows a vehicle, according to an example embodiment of the present invention.

FIG. 2 shows in more detail a recording system logging for software running on a control device, according to an example embodiment of the present invention.

FIG. 3 shows a concatenated list that contains a chain of nodes starting from a list header, according to an example embodiment of the present invention.

FIG. 4 shows a flowchart which represents a method for transferring log data from an execution of a computer program according to one example embodiment of the present invention.

### DETAILED DESCRIPTION OF EXAMPLE EMBODIMENTS

The following detailed description relates to the figures, which show, by way of explanation, specific details and aspects of this disclosure in which the present invention can be executed. Other aspects may be used and structural, logical, and electrical changes may be performed without departing from the scope of protection of the present invention. The various aspects of this disclosure are not necessarily mutually exclusive, since some aspects of this disclosure may be combined with one or more other aspects of this disclosure to form new aspects of the present invention.

Various examples are described in more detail below.

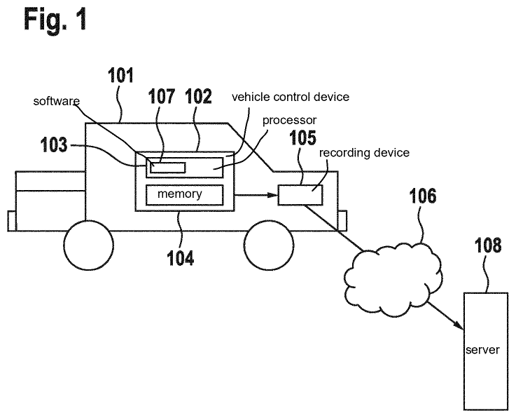

FIG. 1 shows a vehicle 101.

In the example of FIG. 1, the vehicle 101, for example a passenger car or truck, is provided with a vehicle control device (for example, an electronic control unit (ECU)) 102.

The vehicle control device 102 comprises data-processing components, for example a processor (for example, a CPU (central unit)) 103 and a memory 104 for storing control software 107 according to which the vehicle control device 102 operates, and data that are processed by the processor 103.

For example, the stored control software (computer program) comprises instructions that, when executed by the processor, cause the processor 103 to perform driver assistance functions (or to collect driving data) or even to control the vehicle autonomously.

In such a context, it is of great importance that errors in the control software 107 or in the execution of the control software 107 are detected reliably and quickly.

For this reason, according to various embodiments, log data are generated during execution of the control software 107 (for example, “in the field,” i.e., when the vehicle is on the move). These log data are, for example, first stored by the processor 103 in the memory 104 (for example, RAM) and from there transferred to a recording device 105. From there they can then be transferred to a server 108 via a network 106. In the case of the control software in a vehicle, the network 106 is a wireless network. In the case in which the control software is provided in a control device of a stationary robot device (for example, for an industrial robot arm), the network 106 will be for example a wired network (for example, an Ethernet).

The transfer of log data from the control device 102 (i.e., its memory 104) can be effected via an interface with a high data rate (for example, PCIe (Peripheral Component Interconnect Express).

The log data can then be analyzed in the server 108 in various ways. For example, the server 108 can generate, by means of a trace, a representation of the execution of the control software 107 in the form of a Gantt chart, which includes, for example, activation points, execution times, data flow, any (user) log messages for performance measurement, an algorithm-specific trace, etc.

Messages containing log data (also referred to as log information) and generated and output by the processor during execution of the control software 107 are, for example:
Text-based log messages with message arguments and severity level (also referred to as log level, for example fatal, error, warning, info, . . . ) contained therein or appended thereto
Trace messages with a trace context (data flow, execution sequence, . . . ) contained therein or appended thereto
Profiling messages with a time context (points in time, time span identifiers) contained therein or appended thereto
Events, possibly with no further data contained therein or appended thereto (for example, only one event identifier)
Labeled useful-data messages (as in a measurement system)

The first four types of messages mentioned above are typically small and contain a static and a dynamic part. Messages of the last type (i.e., labeled useful-data messages) can be very large (for example, larger than 100 MB for special internal state data). However, for a holistic mechanism for analyzing log data, all types of data must be made available during logging and be linked to a common time frame, because this allows, for example, the developer to track and reproduce the system behavior using special replay and (graphical) analysis tools.

Since a holistic mechanism is being considered, “logging,” i.e., collecting log data, refers not only to collecting the log data (for example, measuring) but also to recording them.

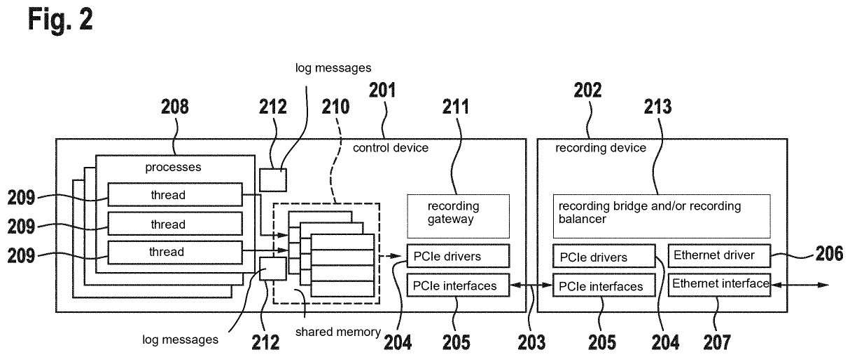

FIG. 2 shows in more detail a recording system 200 for logging for software running on a control device 201.

The control device 201 corresponds, for example, to the control device 107. It is connected via a PCIe bus 203 to a recording device 202, which corresponds, for example, to the recording device 105. For this purpose, the control device 201 and the recording device 202 have corresponding PCIe drivers 204 and PCIe interfaces 205.

The recording device 202 also has an Ethernet driver 206 and an Ethernet interface 207, for example for communication with the server 108. As mentioned above, this can also be a wireless communication interface (with corresponding driver software or communication software). Data transfer can be effected via a “logger” (for example, in the vehicle 101), which forwards the data to the server 108. For example, the logger may be responsible for packaging the log data and transferring them to the server 108 via a mobile phone connection.

The control device 201 can execute multiple processes 208 with multiple threads 209. The threads 209 produce log data which the processor outputs in the form of log messages 212 and which (or the contents of which) are stored in a shared memory 210 which corresponds, for example, to the memory 104. The transfer to the recording device 202 is controlled by a recording gateway 211. The recording device 202 has a recording bridge and/or a recording balancer 213 which controls the forwarding of log data to the server 108.

In order to make possible the analysis of software 107 not only during its development phase but also during operation (for example, when it is being run in the vehicle as in the above example), it is desirable for the logging to have the following properties:
Freedom from interference (for example, there should be no synchronization to a common resource—in other words, it should be possible to log software threads 209 independently of each other).
Deterministic execution (for example, no non-deterministic actions such as creating heap memories are allowed)
Reliable data transfer (in other words, no data should be lost as otherwise a full analysis would not be possible)

The above requirements have a significant impact on the design of the log mechanism, since the log messages 212 written to the memory 210 by the threads 209 (i.e., by the processor) should be as compact as possible so that they do not generate an unnecessary runtime overhead and minimize runtime interference (even during process execution, the processes may output different volumes of log messages).

The recording system 200 decouples logging from the actual log data transportation.

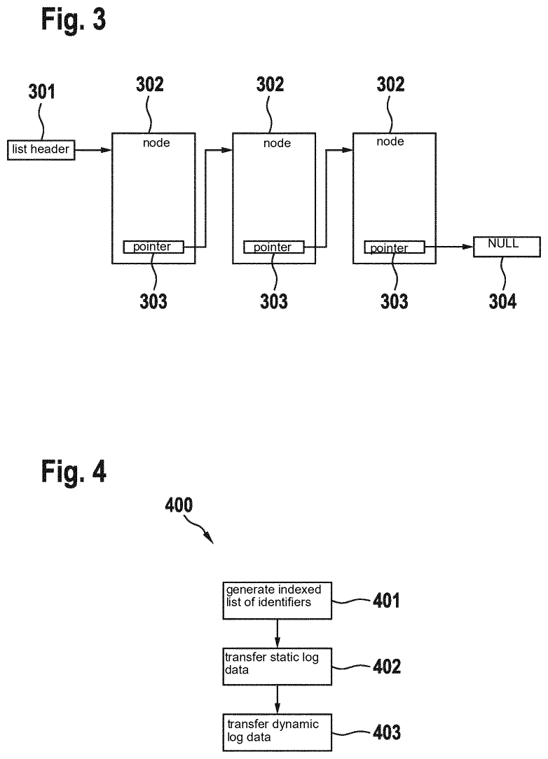

According to various embodiments, in order to keep the log messages 212 as small as possible, each log message 212 is split into a static part (i.e., static log data) and a dynamic part (i.e., dynamic log data). The static log data are collected at the time of compilation of the software 107 (by the particular data processing device that performs the compilation). The data are thus available before the software 107 is executed (i.e., before the main(·) function is executed, for example in the case of software written in C). This is done by forming a concatenated list at the compilation time, as shown in FIG. 3.

FIG. 3 shows a concatenated list 300 that contains a chain of nodes 302 starting from a list header 301.

Each node 302 contains an identifier, static log data and a pointer 303 to the next node 302 (with the last node pointing to NULL 304).

The static log data contain all data that can be extracted from the source code of the software without executing it. This means that at compilation time, the particular data processing device that performs the compilation goes through the source code of the software and from each instruction for outputting log data extracts static log information contained therein (i.e., which is always the same when this instruction is executed), appends an associated node 302 to the chain 302 and into this node inserts the static log information.

Examples of such static log data of such a statement (also called a “log statement”) are:
Severity level (fatal, error, . . . )
Location of the log statement (software component, function, file, line, . . . )
Arguments of the log statement (argument list including argument names and argument type identifiers or a reference to an AST (Abstract Syntax Tree) which describes non-trivial argument layouts)
Format string (for a lazy-late generation of the message—i.e., for a shifting of the effort from the sender side to the receiver side)
Where appropriate, static context information

The static log data can be stored in advance, for example in the server 108. Then, to transfer a log message 212, only the associated dynamic log data need to be transferred.

The log statement can access all information created at compilation time and transfer only the dynamic part (i.e., the dynamic log data). This is done, for example, using the C++ language paradigm “template metaprogramming.”

The dynamic log data only need to contain the runtime part of the log message, such as
the values of the arguments of the log statement
a message identifier (as reference to the static log data in the log statement).
runtime context information (such as for example the identifier of the thread 209 which executed the log statement)

Table 1 shows an example of static log data and dynamic log data for a log message output by a log statement.

TABLE 1

| Static log data | Dynamic log data |
|---|---|
| Log level | Message identifier |
| Format string | Time stamp |
| Location | Thread context |
| . . . | . . . |
| Argument layout | Argument data |
| 1: Type, designation | 1: 42 |
| 2: Type, designation | 2: 666.6 |
| . . . | . . . |

Since, for example, an embedded real-time system cannot use dynamic (i.e., heap) memory, the data structures for the log data have fixed sizes (i.e., in particular the data structures that carry the dynamic log data for a particular log message). This means that the number of arguments in a log statement must be limited.

In the example above, the “type” of an argument stands for common types such as int, float, etc.

However, according to various embodiments, support for user-defined (“custom,” for example, primitive) log-statement-argument data types (also known as log data types) is also added by mapping them to specific type identifiers. This is done by creating a type list at the compilation time (by the particular data processing device that performs the compilation) and assigning to each type (likewise at the compilation time) a type identifier (for example, a hash in a type hash list, which can be specified by an associated hash index).

The hash is only required for user-defined (complex) data types. It represents a kind of checksum over the type definition and is used to access the abstract type description (for example, from a pool of class information). Such a type description can describe any data type (not just the primitive data types directly supported by logging).

This is done, for example, by metaprogramming (i.e., for example by C++ metaprogramming for a C++ type list in the case of software 107 written in C++).

The log-statement-argument data types can then be deserialized in a simple way by using a deserialization handler (on the receiver side), i.e., the raw data output during execution of a log statement using such a log-argument data type can be converted by a deserialization tool into a data structure that matches the data type (which may vary constantly, especially in the course of a development process), for example in order to output appropriately the content of a log message output by the log statement (for example, in a console). This is also possible in embedded systems (despite the limitations regarding dynamic memory). Non-deterministic serialization or even deserialization, however, is not permitted in the embedded system (for example, a control device).

User-defined log-statement-argument data types are useful for recording complex log data structures in an anonymous manner for later analysis. The deserialization of complex data structures at runtime is computationally intensive and is therefore according to one embodiment not carried out not in the control device 102 but outside it, for example by a message extraction process carried out by the server 108 (i.e., on the host side), which is only required when the log data are to be analyzed.

For a user-defined log-argument data type, the static log data of a log statement contain a special log argument type identifier that indicates to the receiver of the log message output by the log statement (i.e., a particular log data sink such as the server 108) that the log argument data in the dynamic log data contained in the log message cannot be interpreted in a trivial manner but that type reflection is required.

Table 2 shows an example of static log data and dynamic log data for a log message output by a log statement, wherein the log statement uses a user-defined log-argument data type.

TABLE 2

| Static log data | Dynamic log data |
|---|---|
| Log level | Message identifier |
| Format string | Time stamp |
| Location | Thread context |
| . . . | . . . |
| Argument layout | Argument data |
| 1: User-defined type, designation | 1: Hash index |
| | Data size |
| | Raw data |
| . . . | . . . |

Here, “user-defined type” is understood to mean the hash of the user-defined log-statement-argument data type (or its index in a list of hash values). The hash serves as an indicator of the log-statement-argument data type. The hash index can be used to access the list of hash values in which the hash was stored at the compilation time. This allows a further optimization of the volume of the data to be transferred.

In order to register a (complex) user-defined log data type, i.e., to cause it to be added to the type list and assigned a hash (with associated hash index), a registration statement is inserted into the software 107 (for example by the user who wants to use the user-defined log data type). The user-defined log data type is thus known to the system (in particular to the data processing device that compiles and creates the static log data) before the static log data are created (and are stored in the server 108).

Table 3 shows a program excerpt in which a user-defined log data type is defined (“SimpleTraceObject”), registered using a registration statement (REGISTER-LOG-DATA-TYPE) and used by a log statement (LOG_INFO).

TABLE 3

struct SimpleTraceObject
{
std::uint16_t activation_sequence_number;
std::uint32_t activation_context_id;
std::uint64_t execution_time_ns;
std::uint32_t[4] data_sequence_numbers;
// ... nesting is also allowed
};
// In the user header
REGISTER_LOG_DATA_TYPE(SimpleTraceObject)
// When logging
LOG_INFO(“It is now time to send a log message: { }”,
CUSTOM_LOG_DATA(traceObject));

Before the LOG_INFO call, an instance of SimpleTraceObject can be created on the stack by
SimpleTraceObject traceObject;
or
auto traceObject=SimpleTraceObject{ };

Table 4 shows an example of a log output generated by deserializing from the log message output (with an output in JSON format assumed here)

TABLE 4

{
“activation_sequence_number”: 22,
“activation_context_id”: 666,
“execution_time_ns”: 1234567,
“data_sequence_numbers”: [ 1, 2, 3, 4 ]
“...”: “...”
}

The strings “activation_sequence_number,” “activation_context_id,” “execution_time_ns” and “data_sequence_numbers” come from (a pool of) type descriptions (for example, class information) that are enriched at the registration of user-defined data types. The handle for each type description is the hash of the particular data type.

Registering user-defined log-statement-argument data types uses a framework that the hash for the log-argument data type (for example, a class hash) that identifies the log-argument data type, which in turn references the log-argument data type information (for example, class information).

This log-argument data type information represents the type AST that is extracted from the program code during the software 107 build process. This is done, for example, by means of a Clang intermediate representation or DWARF debug information generated by the compiler. The information of the log-argument data type also contains for example ABI (Application Binary Interface) information (for example, in the form of flags), which for example indicates the endianness or standard data structure alignment and which is used for the dynamic log data.

The information of the log-argument data type (for example class information) also contains the designations of the contents of the data type as shown in Table 4, i.e., for example, “activation_sequence_number” in the example above.

According to various embodiments, a deserialization framework is used that contains tools and libraries for deserializing data streams containing raw C++ objects with a source ABI (i.e., captured directly from the memory). It can be deserialized into any data format using a reflection mechanism. After a target ABI, the data can also be converted back into raw C++ objects. This framework makes it possible for raw C++ data to be processed from the RAM without a serialization being required in the control device 102 (for example, in an embedded system) that brings the data into a common representation. In this way, sufficient throughput can be ensured when recording the log data. (The focus of the approach is on high data rates and loads and therefore on write optimization.) According to one embodiment, the deserialization framework uses so-called class info and ABI flags to describe data type (standard) layouts and class hashes to identify the data type layouts. Autonomy can be achieved by inserting this information into the recording stream for deserialization in the particular log data sink (host, server).

As explained above, during registration, the hash (for example, class hash) for each user-defined log data type is extracted at the compilation time and, as a further optimization measure, the hash (which has for example four bytes) is assigned an index by which it can be looked up in a list that is added to the static log data and which is also created at the compilation time. In addition, information for each log-argument data type (for example, class information) is generated and made available either in the log-data data stream transferred to the server 108 (for example, using a readable memory managed by separate middleware) or by adding it to the static log data. Table 5 shows the corresponding program code.

TABLE 5
#define CUSTOM_LOG_DATA(data) \ \
logging::getCustomDataTransporter<decltype(data), \
GET_REGISTERED_LOG_DATA_TYPES::getTypeIndex<decltype(data)>
( )>(data)

Since the dynamic log data for each log statement are typically small (i.e., the objects each containing the dynamic log data for a log statement are very small), they are accumulated before their (asynchronous) transfer (for example, from the memory 210 to the recording gateway 211). One reason for this is that on modern hardware platforms the transfer of memory contents typically takes place without copying, i.e., the memory contents are transferred by means of DMA (Direct Memory Access), whereby the ownership rights of the respective memory areas (of the memory 210) are taken over directly.

However, such transfers are expensive (in terms of computational or signaling effort) and are therefore not carried out for every log message 212. Instead, using a memory-to-memory copy operation (for example, memcpy) for the dynamic log data of individual log statements is less expensive overall when the volume of dynamic log data (for each log statement), especially the dynamic log data for user-defined log-statement-argument data types, is small.

According to one embodiment, each thread 209 thus has in the shared memory 210 a dedicated stack-like data structure that is filled with dynamic log data during the execution of the software 107. The log data are then transferred (for example, after termination of the particular thread or process) by notifying the particular receiver (here the recording gateway 211, which in turn initiates the asynchronous transfer). An overflow can be prevented by early notification and transfer.

Table 6 shows an example of such a stack-like data structure for a thread.

TABLE 6
Log data buffer

| Header | Dynamic log data | Dynamic log data |
|---|---|---|
| Number of log | Pointer to next | Pointer to next |
| messages | element | element |
| Pointer to next | Log message | Log message |
| element | identifier | identifier |
| | Time stamp | Time stamp |
| | Thread context | Thread context |
| | . . . | . . . |
| | Argument data | Argument data |
| | 1: Hash index | 1: Hash index |
| | Data size | Data size |
| | Raw data | Raw data |
| | . . . | . . . |

Different priorities can be associated with the log data. For example, it can be the case that if a trace object is lost, a recalculation may no longer be possible. For this reason, the log process can use prioritization functions provided by the respective interfaces and adapters in order to obtain log message prioritization.

In summary, according to various embodiments, a method is provided as shown in FIG. 4.

FIG. 4 shows a flowchart 400 which represents a method for transferring log data from an execution of a computer program according to one embodiment.

In 401, an indexed list of identifiers of user-defined log-statement-argument data types is generated.

In 402, before execution of the program, for each log statement of a set of log statements for outputting log data that is contained in the program, static log data are transferred to a log data receiver, wherein the static log data are log data that, from execution to execution of the program, remain the same for the log statement.

In 403, upon execution of the program, for each log statement of the set of log statements that is executed upon execution of the program, dynamic log data for the log statement are transferred, wherein the dynamic log data are log data that may vary from execution to execution of the program, and wherein, if the log statement uses one of the user-defined log-statement-argument data types for outputting dynamic log data, the dynamic log data contain an index of the identifier of the log-statement-argument data type.

The method in FIG. 4 can be carried out by one or more computers with one or more data processing units. The term “data processing unit” may be understood as any type of entity that enables processing of data or signals. The data or signals can be treated, for example, according to at least one (i.e., one or more than one) special function which is performed by the data processing unit. A data processing unit can comprise or be formed from an analog circuit, a digital circuit, a logic circuit, a microprocessor, a microcontroller, a central processing unit (CPU), a graphics processing unit (GPU), a digital signal processor (DSP), an integrated circuit of a programmable gate array (FPGA) or any combination thereof. Any other way of implementing the respective functions described in more detail herein may also be understood as a data processing unit or logic circuit assembly. One or more of the method steps described in detail here can be executed (e.g. implemented) by a data processing unit by one or more special functions that are performed by the data processing unit.

The approach in FIG. 4 is used for monitoring software. This can, for example, be control software for a robot device. The term “robot device” may be understood to refer to any technical system (comprising a mechanical part whose movement is controlled), such as a computer-controlled machine, a vehicle, a household appliance, a power tool, a manufacturing machine, a personal assistant or an access control system. A control rule for the technical system is learned, and the physical system is then controlled accordingly. The software can, for example, run on an embedded system.

Although specific embodiments have been depicted and described herein, a person skilled in the art will recognize that the specific embodiments shown and described may be replaced with a variety of alternative and/or equivalent implementations without departing from the scope of protection of the present invention. This application is intended to cover any adaptations or variations of the specific embodiments discussed herein.

1-10. (canceled)

11. A method for transferring log data from an execution of a computer program, comprising the following steps:
generating an indexed list of identifiers of user-defined log-statement-argument data types;
before execution of the program, for each log statement of a set of log statements for outputting log data that is contained in the program, transferring static log data to a log data receiver, wherein the static log data are log data that, from execution to execution of the program, remain the same for the log statement; and
upon execution of the program, for each log statement of the set of log statements that is executed upon execution of the program, transferring dynamic log data for the log statement, wherein the dynamic log data are log data that may vary from execution to execution of the program, and wherein, in response to the log statement using one of the user-defined log-statement-argument data types for outputting dynamic log data, the dynamic log data contain an index of the identifier of the log-statement-argument data type.

12. The method according to claim 11, wherein when the log statement uses one of the user-defined log-statement-argument data types for outputting dynamic log data, the dynamic log data contain raw data for the log-statement-argument data type and an indication of a data volume of the raw data.

13. The method according to claim 12, further comprising:
transferring the dynamic log data via a communication channel;
receiving the dynamic log data by the log data receiver;
checking whether the received dynamic log data contain an index of a log-statement-argument data type; and
in response to the dynamic log data containing an index of a log-statement-argument data type, obtaining information about the log-statement-argument data type and converting the dynamic log data into a data structure according to information about the log-statement-argument data type.

14. The method according to claim 13, wherein the information about the log-statement-argument data type includes designations of elements of the log-statement-argument data type.

15. The method according to claim 11, wherein the identifier of each log-statement-argument data type is a hash of a syntax tree of the log-statement-argument data type.

16. The method according to claim 11, wherein the static log data are: (i) a location of the log statement, and/or (ii) a channel of a log message output by the log statement, and/or (iii) an argument layout of the log statement.

17. The method according to claim 11, wherein the log data types are classes of an object-oriented programming language.

18. A data processing arrangement configured to transfer log data from an execution of a computer program, the data processing arrangement configured to:
generate an indexed list of identifiers of user-defined log-statement-argument data types;
before execution of the program, for each log statement of a set of log statements for outputting log data that is contained in the program, transfer static log data to a log data receiver, wherein the static log data are log data that, from execution to execution of the program, remain the same for the log statement; and
upon execution of the program, for each log statement of the set of log statements that is executed upon execution of the program, transfer dynamic log data for the log statement, wherein the dynamic log data are log data that may vary from execution to execution of the program, and wherein, in response to the log statement using one of the user-defined log-statement-argument data types for outputting dynamic log data, the dynamic log data contain an index of the identifier of the log-statement-argument data type.

19. A non-transitory computer-readable medium on which are stored instructions for transferring log data from an execution of a computer program, the instructions, when executed by one or more processors, causing the one or more processors to perform the following steps:
generating an indexed list of identifiers of user-defined log-statement-argument data types;
before execution of the program, for each log statement of a set of log statements for outputting log data that is contained in the program, transferring static log data to a log data receiver, wherein the static log data are log data that, from execution to execution of the program, remain the same for the log statement; and
upon execution of the program, for each log statement of the set of log statements that is executed upon execution of the program, transferring dynamic log data for the log statement, wherein the dynamic log data are log data that may vary from execution to execution of the program, and wherein, in response to the log statement using one of the user-defined log-statement-argument data types for outputting dynamic log data, the dynamic log data contain an index of the identifier of the log-statement-argument data type.
